(19) United States
(12) Patent Application Publication
(10) Pub. No.: US 2024/0073743 A1
(43) Pub. Date: Feb. 29, 2024

(54) DYNAMIC USE OF MULTIPLE WIRELESS NETWORK LINKS TO CONNECT A VEHICLE TO AN SD-WAN

(71) Applicant: VMware, Inc., Palo Alto, CA (US)

(72) Inventor: Daniel J. Beveridge, Valrico, FL (US)

(21) Appl. No.: 18/100,397

(22) Filed: Jan. 23, 2023

Related U.S. Application Data
(60) Provisional application No. 63/401,708, filed on Aug. 28, 2022.

(51) Int. Cl. H04W 28/08; H04W 28/082; H04W 64/00

(52) U.S. Cl. CPC H04W 28/0958; H04W 28/085; H04W 64/006; H04W 84/02

(57) ABSTRACT

Some embodiments provide a novel method for connecting one or more vehicles to a software defined wide area network (SD-WAN). The method deploys an edge router to operate in the vehicle, and configures the edge router to connect to several wireless network links (e.g., 5G cellular links) operating in the vehicle. In some embodiments, the different wireless network links are different mobile hotspot links provided by different telecommunication network providers (e.g., AT&T, Verizon, T-Mobile, Orange, etc.). The method configures the edge router to forward several data message flows from a device operating in the vehicle (e.g., a computer located in the vehicle or a machine (e.g., virtual machine, Pod, container, etc.) executing on a computer located in the vehicle) to the SD-WAN using the several telecommunications network links.

### BACKGROUND

There have been many solutions proposed to date for tracking vehicles through wireless networks. There has also been many products and services to date for allowing devices on a vehicle to connect to computer networks. However, to date, there has not been solutions proposed to date to connect a vehicle to Software Defined Wide Area Networks (SD-WAN) or to use multiple different network links on a vehicle.

### BRIEF SUMMARY

Some embodiments provide a novel method for connecting a vehicle to a software defined wide area network (SD-WAN). The method deploys an edge router to operate on the vehicle, and configures the edge router to connect to several wireless physical network links (e.g., telecommunication network links, such as 5G links) operating in the vehicle. In some embodiments, the different wireless network links are different mobile hotspot links provided by different telecommunication network providers (e.g., AT&T, Verizon, T-Mobile, Orange, etc.). The method configures the edge router to forward several data message flows from a device operating in the vehicle (e.g., a computer located in the vehicle or a machine (e.g., virtual machine, Pod, container, etc.) executing on a computer located in the vehicle) to the SD-WAN using the several wireless network links.

The edge router of some embodiments is one of an edge router appliance, an edge router executing on a computer that operates in the vehicle, or an edge router executing on a machine that executes on the computer. This machine may be one of a VM, a Pod, or a container.

In some embodiments, the method's configuration of the edge router to forward data message flows includes configuring the edge router to forward data messages of each of one or more particular flows along different wireless network links. Different wireless network links in some embodiments provide different transmission rates, different levels of reliability, etc., and the method configures the edge router to forward data message flows along different wireless network links such that the data message flows are forwarded in an optimal configuration.

In some embodiments, the method's configuration of the edge router to forward data message flows includes configuring the edge router to iteratively collect metrics quantifying a set of attributes of each wireless network link at different locations traveled by the vehicle, and select different wireless network links for forwarding data messages at the different locations based on the collected metrics. As the vehicle moves throughout different locations, wireless network links will strengthen or weaken, and the edge router collects metrics for the wireless network links at various different locations to determine the optimal wireless network links at the various locations, such that the edge router can forward data messages using the optimal wireless network links when the vehicle is at each location.

The method's configuration of the edge router to forward data message flows in some embodiments includes configuring the edge router to iteratively collect metrics quantifying a set of attributes of each wireless network link at different times, and select different wireless network links for forwarding data messages at different times based on the collected metrics. In some embodiments, a wireless network link may be optimal at one time of day, and not optimal at another time of day. The edge router collects metrics to determine at which times the wireless network links are optimal in order to use the optimal wireless network link or links throughout the day.

As discussed previously, different wireless network links in some embodiments provide different transmission rates, different levels of reliability, etc. In some embodiments, the set of attributes of the wireless network links quantified by the collected metrics include attributes associated with at least one of reliability and speed of the wireless network link. Different wireless network links provide differing reliability and transmission rates for data messages, and the reliability and speed of the links can change based on the vehicle's location, the time of day, and other various factors. The set of attributes for each link, therefore, may include attributes relating to the link's reliability and speed, and the edge router may forward data messages along different wireless network links based on their reliability and speed.

In some embodiments, the method's configuration of the edge router to forward data message flows includes configuring the edge router to embed the data messages with a sequence number for a destination router of the SD-WAN that receives the data messages. In different embodiments, the destination router may be a gateway of the SD-WAN, a hub forwarding node of a datacenter of the SD-WAN, or an edge forwarding node of a branch site of the SD-WAN. Because the data messages can be sent along different wireless network links, the data messages may not be received at the destination router in the same order in which they were sent. The destination router may then use the sequence numbers embedded in the data messages to put the data messages in their correct sequential order before forwarding the data messages to a subsequent destination in the SD-WAN. This ensures that data messages are optimally sent to the destination router by being sent along different wireless network links, and that the data messages are sent in the correct order to their subsequent destination.

The method of some embodiments includes configuring a deep packet inspector to perform a deep packet inspection (DPI) on a particular flow to identify a type of traffic carried by data messages of the particular flow. The method also configures the edge router to select, based on the identified traffic type, a particular wireless network link from the several wireless network links to forward the particular flow. The type of traffic may be a critical type of traffic that requires a highly reliable wireless network link, a type of traffic that requires a fast wireless network link, or some other type of traffic that only a particular wireless network link can forward such that it satisfies the requirement(s) of that type of traffic.

In some embodiments, configuring the edge router to select the particular wireless network link based on the identified traffic type includes providing the edge router with a set of rules that specify different desired link attributes for different types of traffic. This set of rules in some embodiments includes a rule specifying selecting a wireless network link with a highest reliability score for a particular type of traffic. For a critical type of traffic, the most reliable wireless network link should be used. When forwarding a flow of this traffic type, the edge router may compute reliability scores for each of the wireless network links (e.g., using collected metrics quantifying attributes of the links) and, using the rule, select the link with the highest reliability score to use to forward the critical flow. In some embodiments, the link with the highest reliability score does not have the highest transmission rate score, meaning that the most reliable link is not the fastest. In such embodiments, while the critical flow is not sent along the fast link, the critical flow is sent along the most reliable link, as specified by the rule in the rule set.

The set of rules in some embodiments includes a rule specifying selecting a wireless network link with a pre-requisite reliability score for a particular type of traffic. In some embodiments, critical flows specify a required reliability score for the link on which it is forwarded. In such embodiments, two or more wireless links may have pre-requisite reliability scores that satisfy the score required by the flow, and the edge router may select the wireless network link that satisfies the required reliability score but is not the most reliable link.

In some embodiments, the set of rules includes a rule that specifies selecting a wireless network link with a lowest transmission time score for a particular type of traffic. As discussed previously, a particular type of traffic may require being sent along the fastest wireless network link. When forwarding a flow of this traffic type, the edge router may compute transmission time scores for each of the wireless network links (e.g., using collected metrics quantifying attributes of the links) and, using the rule, select the link with the lowest transmission time score (equating to the fastest link) to use to forward the flow.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example vehicle and controller cluster for which some embodiments of the invention are implemented.

FIGS. 2 and 3 illustrate an example vehicle that communicates with various components of an SD-WAN.

FIG. 4 illustrates an example of N vehicles that communicate with various components of an SD-WAN.

FIG. 5 conceptually illustrates a process of some embodiments for configuring an edge router of a vehicle.

FIG. 6 conceptually illustrates a process of some embodiments for selecting one of several links for forwarding data message flows.

FIG. 7 illustrates an example flow being sent along different telecommunication network links from a vehicle to a destination router of an SD-WAN.

FIG. 8 illustrates an example vehicle that uses deep packet inspection (DPI) to forward flows from the vehicle to a destination in an SD-WAN using different telecommunication network links.

FIG. 9 illustrates example data messages that are embedded with sequence numbers for a destination router to re-sequence and forward to a subsequent destination in the correct order.

FIG. 10 illustrates an example vehicle selecting different links at different times for forwarding data message flows.

FIG. 11 illustrates an example vehicle selecting different links at different locations for forwarding data message flows.

FIG. 12 conceptually illustrates a process of some embodiments for generating metrics for network links.

FIG. 13 illustrates an example vehicle travelling along a route for which link selections have been predicted.

FIG. 14 conceptually illustrates a process of some embodiments for proactively selecting links along various locations of a future route of a vehicle.

FIG. 15 illustrates an example vehicle travelling along a route in which a future location does not have a predicted link selection.

FIG. 16 conceptually illustrates a process of some embodiments for dynamically distributing data message flows across multiple network links by predicting metrics of each network link at future locations of the vehicle.

FIG. 17 illustrates an example linear regression graph generated for predicting metrics of a particular link at a vehicle's future location.

FIG. 18 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for connecting one or more vehicles to a software defined wide area network (SD-WAN). The method deploys an edge router to operate in the vehicle, and configures the edge router to connect to several wireless network links (e.g., wireless layer 1 physical network links) operating in the vehicle. In the embodiments described below, the different wireless network links are different mobile hotspot links (e.g., 5G cellular links) provided by different telecommunication network providers (e.g., AT&T, Verizon, T-Mobile, Orange, etc.). However, other embodiments use other types of wireless network links. The method configures the edge router to forward several data message flows from a device operating in the vehicle (e.g., a computer located in the vehicle or a machine (e.g., virtual machine, Pod, container, etc.) executing on a computer located in the vehicle) to the SD-WAN using the several telecommunications network links.

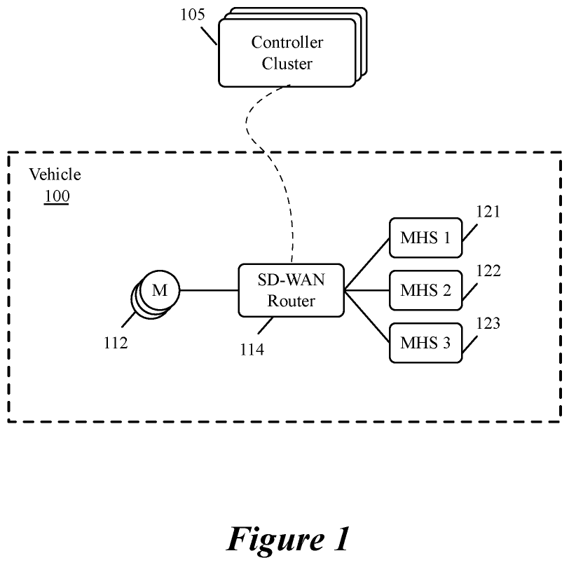

FIG. 1 illustrates an example of a vehicle 100 and a controller cluster 105 that implement the method of some embodiments of the invention. As shown, the vehicle 100 includes a set of one or more compute machines 112, an SD-WAN router 114 and several network links 121-123. The controller cluster 105 serves as a central point for managing (e.g., defining and modifying) configuration data that is provided to the components of the vehicle 100 to configure some or all of the operations. In some embodiments, this controller cluster 105 is in one or more public cloud datacenters, while in other embodiments it is in one or more private datacenters. In some embodiments, the controller cluster 105 has a set of manager servers that define and modify the configuration data, and a set of controller servers that distribute the configuration data to the vehicle 100. In some embodiments, the controller cluster 105 directs the SD-WAN router 114 of the vehicle 100 to use certain gateways (i.e., assigns a gateway to the SD-WAN router 114).

The SD-WAN router 114 of some embodiments is one of an edge router appliance, an edge router executing on a computer that operates in the vehicle 100, or an edge router executing on a machine that executes on the computer. This machine may be one of a VM, a Pod, or a container. In some embodiments, the controller cluster 105 configures the SD-WAN router 114 to forward different data message flows (or data messages of a flow) along different telecommunication network links 121-123. The network links 121-123 are in some embodiments different mobile hotspot links provided by different telecommunication network providers (e.g., AT&T, Verizon, T-Mobile, Orange, etc.). These network links 121-123 connect the vehicle 100 to an SD-WAN.

The controller cluster 105 of some embodiments configures the SD-WAN router 114 to forward data messages along different network links 121-123 such that the data messages are forwarded in an optimal configuration. In some embodiments, different wireless network links provide different transmission rates, different amounts of reliability, etc. In such embodiments, the controller 105 provides the SD-WAN router 114 with link selection rules for selecting links for forwarding data message flows. In other embodiments, the controller cluster 105 configures the SD-WAN router 114 to iteratively (1) collect metrics quantifying a set of attributes of each network link 1210123, and (2) select different network links 121-123 for forwarding data messages based on the collected metrics. These sets of attributes of the network links 121-123 quantified by the collected metrics may include attributes associated with at least one of reliability and speed of the network link 121-123. The network links 121-123 provide different levels reliability and transmission rates for data messages, and the reliability and speed of these links 121-123 can change based on the vehicle 100's location, the time of day, and other various factors. The set of attributes for each link 121-123, therefore, may include attributes relating to the link's reliability and speed, and the SD-WAN router 114 may forward data messages along the different network links 121-123 based on their reliability and speed. Any suitable performance or non-performance metrics associated with network links may be used to determine optimal links.

The controller cluster 105 of some embodiments configures the SD-WAN router 114 to iteratively (1) collect metrics quantifying a set of attributes of each network link 1210123 at different locations traveled by the vehicle 100, and (2) select different network links 121-123 for forwarding data messages at the different locations based on the collected metrics. As the vehicle 100 moves throughout different locations, the network links 121-123 will strengthen or weaken as the vehicle 100 moves closer to and farther away from different cellular towers. The SD-WAN router 114 may collect metrics for the network links 121-123 at various different locations to determine which links are optimal at the various locations, such that the SD-WAN router 114 can forward data messages using the optimal wireless network links when the vehicle is at each location. For instance, the SD-WAN router may use metrics for the network links 121-123 to determine that network link 121 is the optimal link at a first location, while network link 122 is the optimal link at a second location. Based on this determination, the SD-WAN router 114 forwards data messages using the first network link 121 when the vehicle 100 is at the first location, and forwards data messages using the second network link 122 when the vehicle 100 is at the second location. This ensures that data messages are forwarded using the optimal link, no matter the location of the vehicle 100.

The controller cluster 105 may also configure the SD-WAN router 114 to iteratively (1) collect metrics quantifying a set of attributes of each network link 121-123 at different times, and (2) select different network links for forwarding data messages at different times based on the collected metrics. In some embodiments, a network link may be optimal at one time of day, and not optimal at another time of day. In order to ensure that the optimal link is used, the SD-WAN router 114 uses the collected metrics to determine which network link 121-123 is optimal at each time of the day, and uses the optimal link at any given time throughout the day for forwarding data messages.

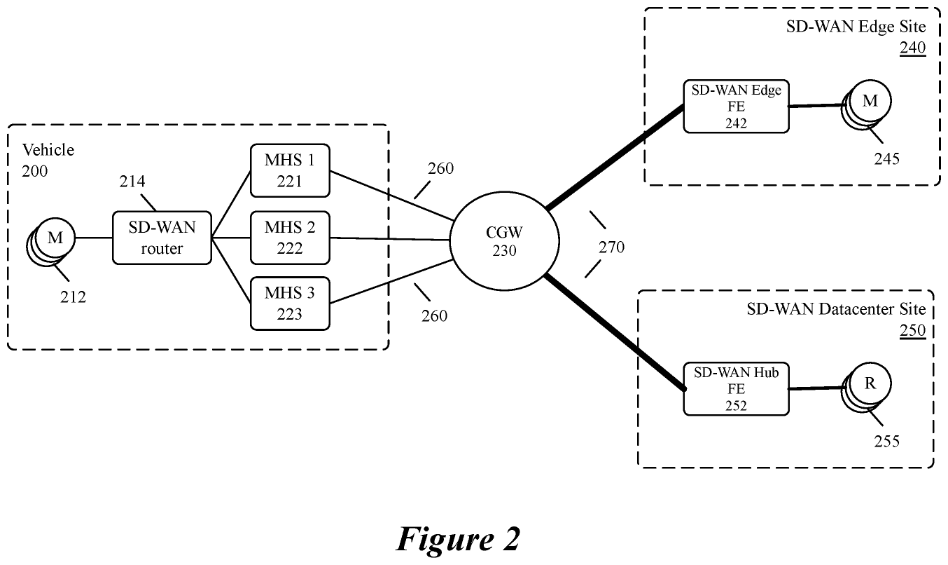

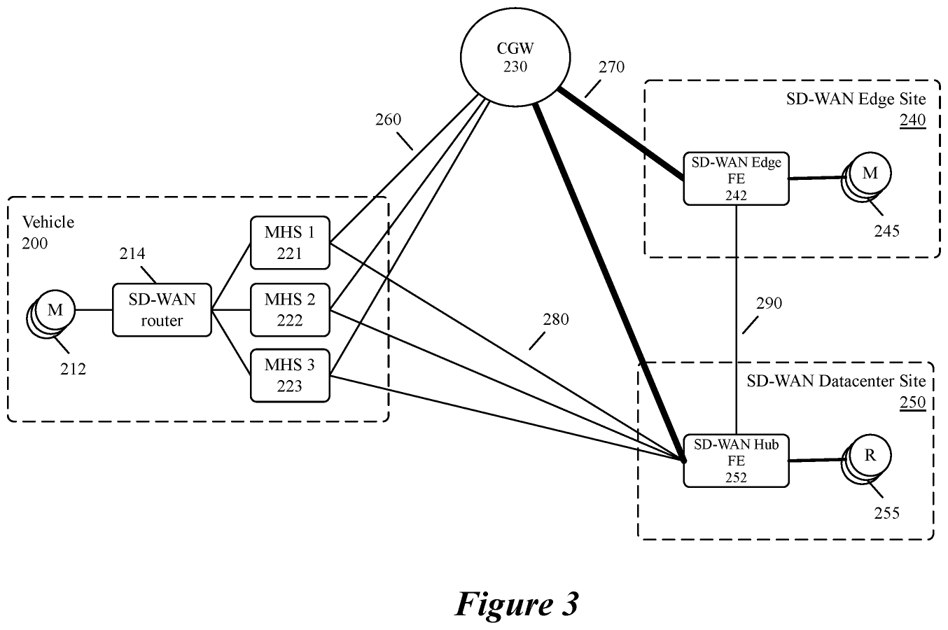

As discussed previously, an SD-WAN router of a vehicle uses the various network links to connect to an SD-WAN. FIGS. 2 and 3 illustrate an example vehicle 200 that communicates with various components of an SD-WAN, i.e., a cloud gateway (CGW) 230, an SD-WAN edge site 240, and an SD-WAN datacenter site 250. The vehicle 200 includes one or more compute machines 212, an SD-WAN router 214, and network links 221-223 for forwarding data messages to the various components of the SD-WAN. The edge site 240 is a branch site (e.g., of an entity that owns the vehicle 200 or is associated with the owner of this vehicle) that includes an SD-WAN forwarding element (FE) 242 and a set of one or more machines 245. The datacenter site 250 includes a hub forwarding node 252 and a set of one or more resources 255 which may be used by the edge site 240 or the vehicle 200. The datacenter SD-WAN forwarding node 252 is referred to as a hub node because in some embodiments this forwarding node can be used to connect to other edge forwarding nodes of the branch site 240 and of the vehicle 200. The hub node in some embodiments provides services (e.g., middlebox services) for packets that it forwards between a vehicle and a branch site. The hub node also provides access to the datacenter resources 255.

In FIG. 2, the network links 221-223 of the vehicle 200 are shown to connect to the CGW 230 through connection links 260. In some embodiments, these connection links include secure and unsecure connection links, while in other embodiments they only include secure connection links. Multiple secure connection links (e.g., multiple secure tunnels that are established over multiple physical links) can be established between two components (e.g., a vehicle and a gateway, or an edge node and a gateway) in some embodiments.

The CGW 230 connects to the edge site 240 and the datacenter site 250 through secure connection links 270 that connect to the edge FE 242 of the edge site 240 and the hub FE 252 of the datacenter site 250. These connection links 270 are shown as bolded lines to represent the three telecommunication providers that provide the three network links 221-223 for the vehicle 200. In some embodiments, the edge site 240 and datacenter site 250 each include three separate forwarding elements for receiving communications with the vehicle 200 along the different network links 221-223. In other embodiments, only one forwarding element on each site communicates with the vehicle 200.

In some embodiments, the vehicle 200 connects directly to the edge site 240 and the datacenter site 250, without communicating through the CGW 230. FIG. 3 illustrates the same vehicle 200, CGW 230, edge site 240, and datacenter site 250, with secure connection links 280 connecting the network links 221-223 directly to the hub FE 252 of the datacenter site 250. Using these links 280, the vehicle 200 is able to access the edge site 240 and the datacenter site 250 without communicating through the gateway 230. This figure also illustrates a secure connection link 290 between the edge site 240 and the datacenter site 250. In some embodiments, the vehicle 200 accesses the edge site 240 through the datacenter site 250.

The hub FE 252 of the datacenter site 250 acts as a hub in order for the vehicle 200 to communicate with the edge FE 242 through the datacenter site 250. More specifically, in some embodiments, the hub 252 serves as the hub node of the SD-WAN in that it allows programs executing at an SD-WAN node (e.g., programs executing on the machines 212 operating in the vehicle) access to the datacenter resources 255 as well as access to the machines at the SD-WAN nodes (e.g., access to the machines 245 at the edge site 242). When providing access to another edge site's machines through that edge site's forwarding router (e.g., to machines 245 through the edge forwarding router 242), the hub serves as the hub node of an SD-WAN that is implemented in a hub-and-spoke architecture. In some embodiments, the SD-WAN performs middlebox services (e.g., firewall services, load balancing services, NAT services, etc.) to the SD-WAN traffic that passes through the hub. Lastly, in some embodiments, the cloud gateway 230 can direct the vehicle 200 to directly connect to the edge site 240 without passing its data messages first through the cloud gateway or the datacenter hub 252.

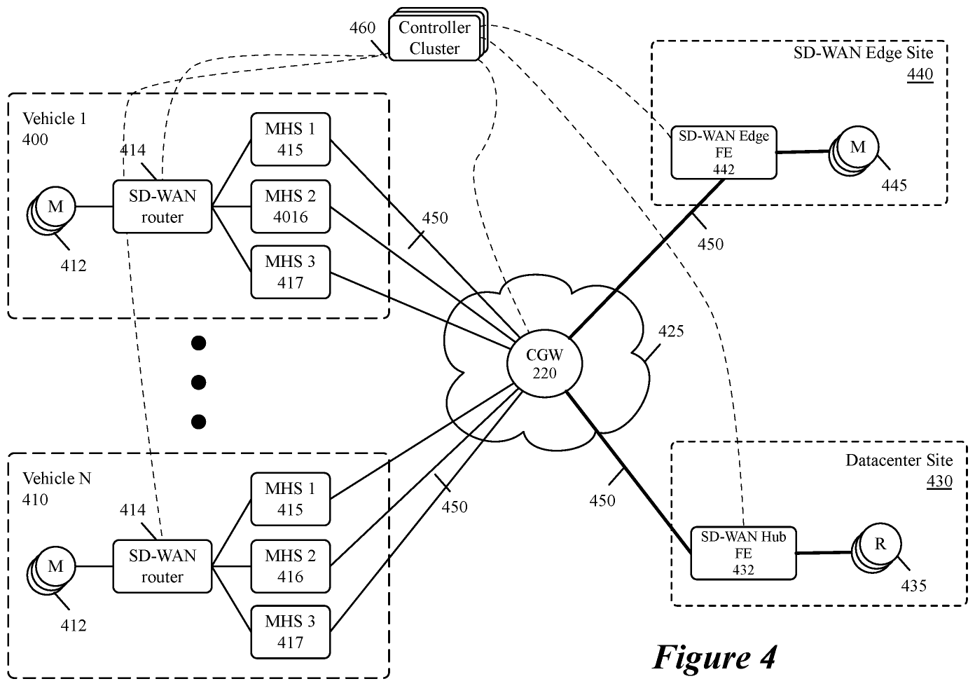

FIG. 4 illustrates an example of vehicles 400 and 410 that communicate with various components of an SD-WAN. Any number of vehicles 1-N may be used. The vehicles 400 and 410 respectively include sets of one or more compute machines 412, SD-WAN routers 414, and network links 415-417. The SD-WAN includes a cloud gateway 420, a datacenter site 430, and a branch site 440.

The CGW in some embodiments is a forwarding element that is in a private or public datacenter 425. The CGW 420 in some embodiments has secure connection links (e.g., tunnels) with edge forwarding elements (e.g., SD-WAN edge FE 442) at multi-machine sites (e.g., SD-WAN edge site 440 with multiple machines 445), such as branch offices, datacenters, etc. These multi-machine sites are often at different physical locations (e.g., different buildings, different cities, different states, etc.) and are referred to below as multi-machine sites or nodes. Two multi-machine sites 430 and 440 are illustrated in FIG. 4, with one of them being a branch site 440, and one being a datacenter site 430. The branch site is shown to include an edge forwarding node 442, while the datacenter site 430 is shown to include a hub forwarding node 432. The edge forwarding element (e.g., SD-WAN edge FE 442) exchanges data messages with one or more cloud gateways 420 through one or more connection links 450 (e.g., multiple connection links available at the edge forwarding element).

When multiple such links are defined between an edge node and a gateway, each secure connection link in some embodiments is associated with a different physical network link between the edge node and an external network. For instance, to access external networks, an edge node in some embodiments has one or more commercial broadband Internet links (e.g., a cable modem, a fiber optic link) to access the Internet, an MPLS (multiprotocol label switching) link to access external networks through an MPLS provider's network, a wireless cellular link (e.g., a 5G LTE network). In some embodiments, the different physical links between the edge node 442 and the cloud gateway 420 are the same type of links (e.g., are different MPLS links).

In some embodiments, the edge forwarding node 442 can also have multiple direct links 450 (e.g., secure connection links established through multiple physical links) to a datacenter hub node 432. Again, the different links in some embodiments can use different types of physical links or the same type of physical links. Also, in some embodiments, the edge forwarding node 442 of the branch site can connect to a SD-WAN router of a vehicle (1) directly through one or more links 450, or (2) through a cloud gateway or datacenter hub to which the edge forwarding node connects through two or more links 450. Hence, in some embodiments, the edge forwarding node 442 of the branch site 440 can use multiple SD-WAN links 450 to reach an SD-WAN router (e.g., 204) of a vehicle (e.g., 400), or a hub forwarding node 432 of a datacenter site 430.

The cloud gateway 420 in some embodiments is used to connect an SD-WAN router of a vehicle (e.g., SD-WAN router 414 of vehicle 410) to an SD-WAN forwarding node (e.g., edge forwarding element 442) through at least two secure connection links 450 between the gateway 420 and the SD-WAN router and between the gateway 420 and the forwarding element at the SD-WAN site (e.g., branch site 440 or datacenter site 430). In some embodiments, the cloud gateway 420 also provides network data from a vehicle to a multi-machine site or from one multi-machine site to another multi-machine site (e.g., provides the accessible subnets of one site to another site). Like the cloud gateway 420, the hub forwarding element 432 of the datacenter 430 in some embodiments can be used to connect an SD-WAN forwarding node 442 of a branch site to an SD-WAN router of a vehicle through at least two secure connection links 450 between the hub 432 and the SD-WAN router and between the hub 432 and the forwarding element at the branch site 440.

In some embodiments, each secure connection link between two SD-WAN forwarding nodes (i.e., CGW 420 and edge forwarding node 442) is formed as a VPN (virtual private network) tunnel between the two forwarding nodes. In this example, the collection of the SD-WAN forwarding nodes (e.g., forwarding element 442 and gateways 420) and the secure connections 450 between the forwarding nodes forms a virtual network for a particular entity that spans at least public or private cloud datacenter 425 to connect the branch and datacenter sites 430 and 440.

In some embodiments, secure connection links are defined between gateways in different public cloud datacenters to allow paths through the virtual network to traverse from one public cloud datacenter to another, while no such links are defined in other embodiments. Also, in some embodiments, the gateway 420 is a multi-tenant gateway that is used to define other virtual networks for other entities (e.g., other companies, organizations, etc.). Some such embodiments use tenant identifiers to create tunnels between a gateway and edge forwarding element of a particular entity, and then use tunnel identifiers of the created tunnels to allow the gateway to differentiate data message flows that it receives from edge forwarding elements of one entity from data message flows that it receives along other tunnels of other entities. In other embodiments, gateways are single-tenant and are specifically deployed to be used by just one entity.

FIG. 4 illustrates a cluster of controllers 460 that serves as a central point for managing (e.g., defining and modifying) configuration data that is provided to the edge nodes and/or gateways to configure some or all of the operations. In some embodiments, this controller cluster 460 is in one or more public cloud datacenters, while in other embodiments it is in one or more private datacenters. In some embodiments, the controller cluster 460 has a set of manager servers that define and modify the configuration data, and a set of controller servers that distribute the configuration data to the edge FEs, hubs and/or gateways. In some embodiments, the controller cluster 460 directs edge forwarding elements and hubs to use certain gateways (i.e., assigns a gateway to the edge forwarding elements and hubs). The controller cluster 460 also provides next hop forwarding rules and load balancing criteria in some embodiments.

To connect the vehicles 400 and 410 to the cloud gateway 420, datacenter site 430, and branch site 440, the SD-WAN routers 414 use the network links 415-417. As discussed previously, a controller cluster 460 configures an SD-WAN router to iteratively (1) collect metrics quantifying a set of attributes of each network link in the vehicle, and (2) select different network links for forwarding data messages to components of the SD-WAN based on the collected metrics. In some embodiments, the controller cluster 460 configures an SD-WAN router (e.g., 414) to embed data messages with a sequence number for a destination router of the SD-WAN that receives the data messages. Further information regarding re-sequencing will be described below.

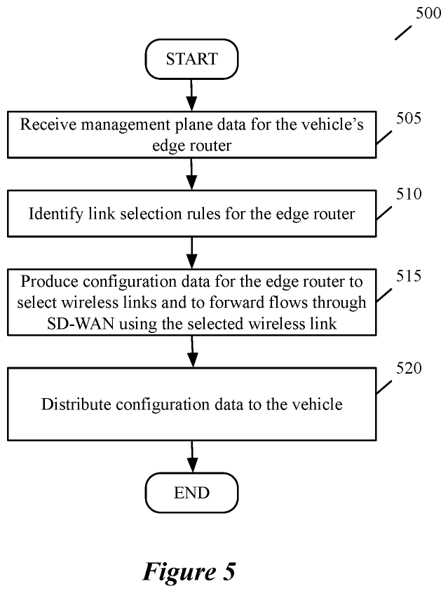

FIG. 5 conceptually illustrates a process 500 used by a controller cluster 460 to configure the SD-WAN edge router (e.g., routers 214 or 414) of a vehicle. The process 500 when the controller cluster receives (at 505) input from a management plane (MP) interface, and generated configuration data based on this input. This input can come from a MP program or from an administrator of the network that interfaces with the management plane. The vehicle edge router in some embodiments is one of an edge router appliance, an edge router executing on a computer that operates in the vehicle, or an edge router executing on a machine (e.g., a VM, a Pod, or a container) that executes on the computer.

Next, at 510, the process 500 identifies a set of one or more link selection rules for the edge router of the vehicle. The link selection rules may be provided directly from a user or administrator, or the controller set may receive data from the user for the controller to generate the link selection rules. As further discussed below, the vehicle's edge router in some embodiments selects links for forwarding different flows or different data messages of a flow in order to forward data messages in an optimal configuration.

The identified set of link-selection rules in some embodiments includes a rule specifying selecting a wireless network link with a highest reliability score for a particular type of traffic (e.g., for a critical type of traffic). When forwarding a flow of this traffic type, the edge router may compute reliability scores for each of the wireless network links (e.g., using collected metrics quantifying attributes of the links) and, using the rule, select the link with the highest reliability score to use to forward the critical flow.

In some cases, the link with the highest reliability score might not have the highest transmission rate score, meaning that the most reliable link might not be the fastest. In such cases, a critical flow might not be sent along the fastest link or the link with the highest throughput, but is instead sent along the most reliable link, as specified by the rule in the rule set. The set of rules in some embodiments includes a rule specifying selecting a the fastest wireless network link that meets a threshold reliability score for a particular type of traffic. In some such embodiments, two or more wireless network links may have pre-requisite threshold reliability scores, and in such a case, the edge router would then select the network link that link that has the faster speed.

In some embodiments, the set of rules includes a rule that specifies selecting a wireless network link with a lowest transmission time score for a particular type of traffic. As discussed previously, a particular type of traffic may require being sent along the fastest wireless network link. When forwarding a flow of this traffic type, the edge router may compute transmission time scores for each of the wireless network links (e.g., using collected metrics quantifying attributes of the links) and, using the rule, select the link with the lowest transmission time score (equating to the fastest link) to use to forward the flow.

Next, the process 500 produces (at 515) configuration data for configuring the edge router to perform link selection processes based on the link selection rules for forwarding data messages along links of the vehicle, and to forward flows through the selected links. For different flows, the configuration data can configure the edge router to perform differently, e.g., to select links with different metrics and/or to select one or more links.

The process 500 then distributes (at 520) the produced configuration data to the vehicle's edge router to use to select links for the different flows and forward the flows through the selected links. In some embodiments, the configuration data configures the edge router to forward flows from a device operating in the vehicle (e.g., a computer located in the vehicle or a machine (e.g., virtual machine, Pod, container, etc.) executing on a computer located in the vehicle) to the SD-WAN. The configuration data in some embodiments configures the edge router to use its link selections to forward flows in the most optimal configuration. For instance, the controller may provide a link selection rule to the edge router specifying that a particular flow must be sent along the most reliable link.

The configuration data also configures the vehicle's edge router to connect to wireless network links in the vehicle. The configuration data also includes next-hop forwarding rules in some embodiments that direct the vehicle's edge router to forward flows to a cloud gateway, a datacenter hub (e.g., to access resources of the datacenter) and/or a branch site's edge router (e.g., to send data messages to an edge node of the branch site). After 520, the process ends.

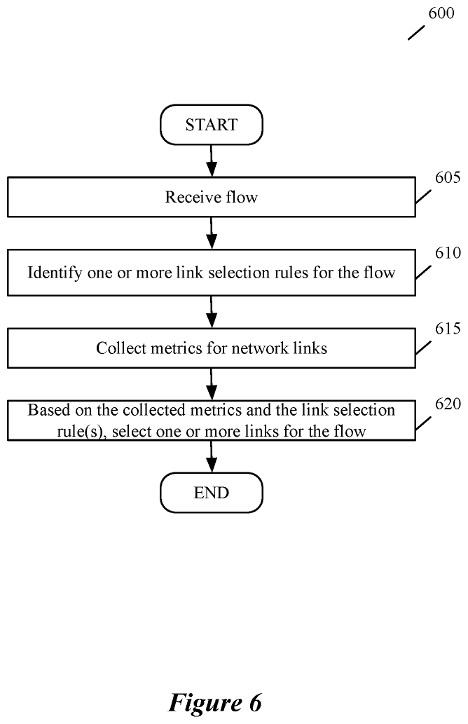

FIG. 6 conceptually illustrates a process 600 that the vehicle's edge router (e.g., SD-WAN router 114, 214 and 414) performs in some embodiments to select one or more links for a flow and to forward data messages of the flow along the selected link(s). The process 600 begins when the edge router receives (at 605) the first data message (e.g., the first packet) of the flow. This flow may be received from a machine executing on a computer operating on the vehicle, and may be sent to a destination machine in a datacenter or branch site connected to the SD-WAN.

At 610, the process 600 identifies one or more link selection rules for the flow. In some embodiments, the edge router receives link selection rules from the controller cluster and stores them in a local database. In some embodiments, the process selects the link selection rule(s) by matching the received flow's attributes (e.g., its five tuple attributes, and/or dynamically identified attributes, such as its AppID that identifies the type of traffic carried in the flow's payload) with the match attributes of the link selection rules that it stores in its local database. Each link-selection rule either identifies a wireless link specifically, or specifies one or more criteria for the edge router to use to select one or more wireless links for the flow.

Next, at 615, the process 600 collects metrics for the network links operating in the vehicle. In some embodiments, an identified link selection rule specifies that the particular flow must be sent along a link that is associated with certain metrics. For example, the link selection rule may specify that the particular flow must be sent along the fastest wireless network link, and the edge router must then collect metrics for each link to determine which link is fastest. One or more processes executing on the vehicle's computer continuously collect metrics for each wireless link of the vehicle, and store these metrics in a local database stored on the same or another computer operating on the vehicle. In some embodiments, the metrics are collected from the controller set that configures the edge router. Conjunctively, or alternatively, the metrics are collected from a server or another vehicle that generated the metrics and/or are collected by the edge router by performing metrics generation processes on the links, as described further below.

Based on the identified link-selection rule(s) and the collected metric, the process 600 selects (at 620) one or more links for forwarding the flow through the SD-WAN to its destination. For instance, the flow's matching link-selection rule might specify that the most reliable wireless link should be used for the flow, and based on this rule, the process 600 selects the wireless link with the most reliable metric score.

In some embodiments, the edge router identifies multiple link selection rules for the flow, specifying using different links for different data messages in the flow for optimal link configuration. In such embodiments, the edge router selects different links for different data messages in the received flow. After selecting one or more links for forwarding the flow, the edge router uses the selected link(s) to forward the data messages of the flow to its destination along the selected link(s).

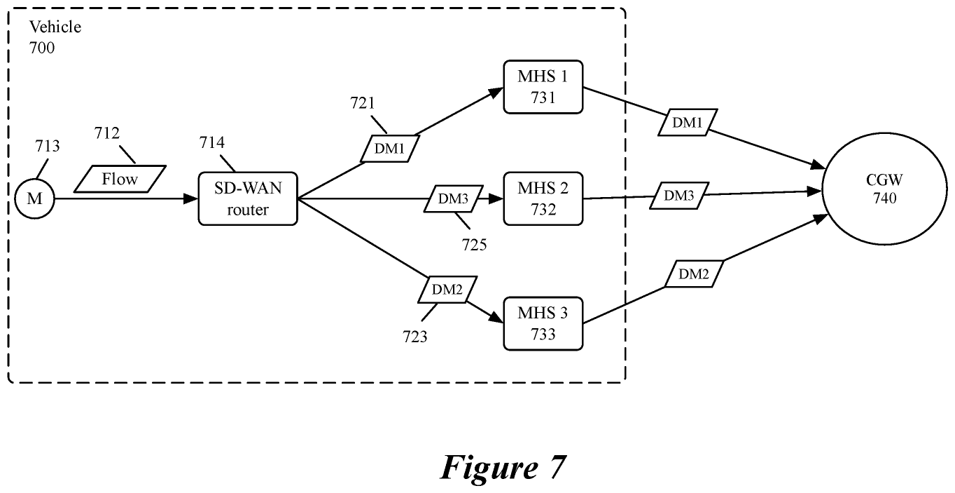

FIG. 7 illustrates an example flow 712 being sent from a machine 713 operating on a vehicle 700 to a cloud gateway 740 of an SD-WAN. The flow 712 is received by the SD-WAN router 714 for the router to forward different data messages of the flow 712 along different links. Using link selection processes, such as the process 600 of FIG. 6, the SD-WAN router 714 forwards the flow's first set of data message 721 along the first network link 731 to the CGW 740, the flow's second set of data messages 723 along the third network link 733 to the CGW 740, and the flow's third set of data messages along the second network link 732 to the CGW 740.

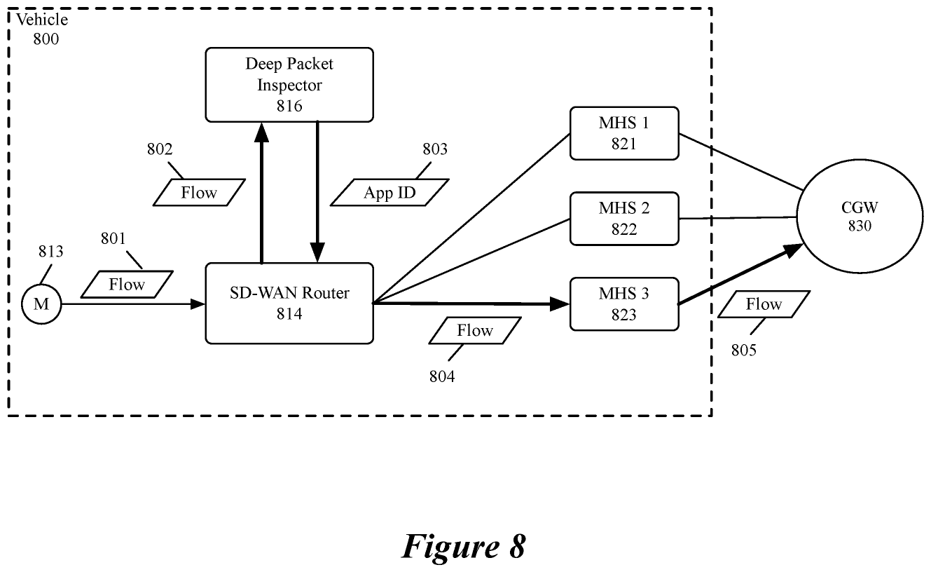

In some embodiments, an edge router of a vehicle uses deep packet inspection (DPI) to forward flows from the vehicle to a destination in an SD-WAN. FIG. 8 illustrates an example vehicle 800 that includes an SD-WAN router 814, a deep packet inspector 816, and wireless network links 821-823 to connect to a cloud gateway 830 of an SD-WAN. In this example, a particular flow is received (at 801) by the SD-WAN router 814 from a machine 813 executing on the vehicle 800. After receiving the flow, the SD-WAN router 814 sends the flow to the deep packet inspector 816 at 802. The deep packet inspector 816 receives the flow and performed DPI on the flow to return an application identifier (App ID) for the flow. This App ID identifies the application that is the source of the flow.

The deep packet inspector 816 then sends the App ID to the SD-WAN router 814 at 803 so the SD-WAN router 814 can select a network link for forwarding the flow to the cloud gateway 830. In some embodiments, the SD-WAN router 814 performs a link selection process similar to the process 600 of FIG. 6 by using the App ID of the flow to identify a link selection rule associated with that App ID. Once a link is selected, the SD-WAN router 814 forwards the flow along the selected link at 804 and to the cloud gateway 830 at 805. In this example, network link 823 has been selected for forwarding the flow.

In some embodiments, the SD-WAN router 814 uses the deep packet inspector 816 to perform DPI on a particular flow to identify a type of traffic carried by data messages of the particular flow. Once the App ID is received from the deep packet inspector 816, the SD-WAN router 814 can determine the type of traffic of the flow and select, based on the identified traffic type, a particular wireless network link from the several wireless network links to forward the particular flow. The type of traffic may be a critical type of traffic that requires a highly reliable wireless network link, a type of traffic that requires a fast wireless network link, or some other type of traffic that only a particular wireless network link can forward such that it satisfies the requirement(s) of that type. For example, based on the App ID from the deep packet inspector 816, the SD-WAN router 814 can determine that this flow is a critical flow. Once the flow is determined to include critical traffic, the SD-WAN router 814 can select a network link that is the most reliable. Reliability can be determined based on generated metrics for the various links 821-823. Once the most reliable link is determined, the SD-WAN router 814 can forward the critical flow along the most reliable link.

As discussed previously, an edge router can forward data messages of a flow along different wireless network links to a destination. In some embodiments, the edge router forwards the data messages to a destination router for the gateway to forward to a subsequent destination. For instance, an edge router may forward data messages of one flow along three separate network links to a gateway, and the gateway will forward the data messages to a destination edge node of a branch site. In some embodiments, because the data messages can be sent along different wireless network links, the data messages may not be received at the destination router in the same order in which they were sent. In such embodiments, the edge router may embed the data messages with a sequence number in order for the destination router to determine the correct order of the data messages and send them in the correct order. In some embodiments, the sequence numbers are embedded in a header of each data message. In other embodiments, the sequence numbers are embedded in a payload of each data message.

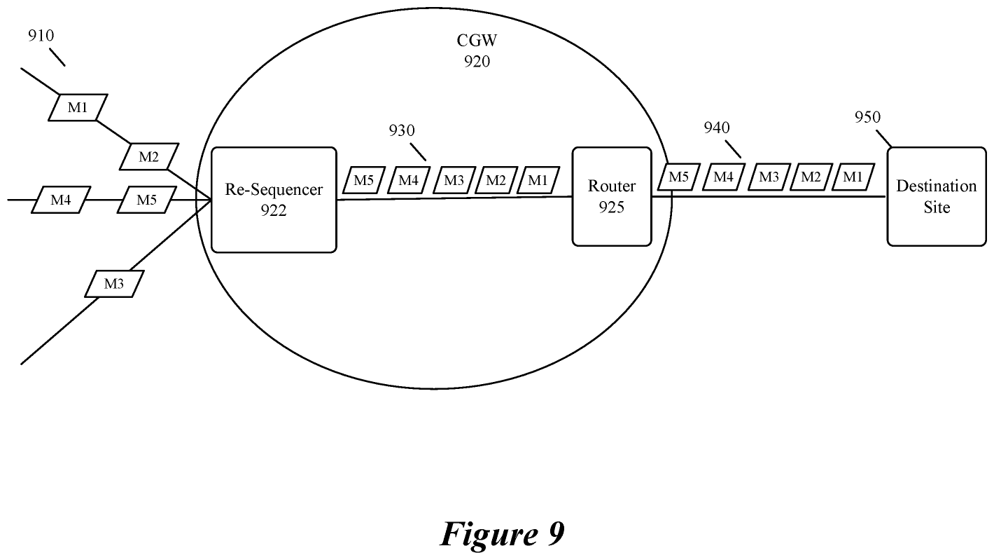

FIG. 9 illustrates an example of a flow that includes five data messages 910 being sent along three wireless network links to a cloud gateway 920. These data messages 910 are embedded with sequence numbers. The data messages 910 are received at a re-sequencer 922 of the gateway 920. The re-sequencer 922 uses the embedded sequence numbers to put the data messages in their correct sequential order, regardless of whether the re-sequencer 922 received them in that correct sequential order or not. In some embodiments, the re-sequencer 922 leaves the sequence numbers embedded into the data messages. In other embodiments, the re-sequencer 922 removes the sequence numbers from the data messages.

Once in their correct order, the re-sequencer 922 sends the data messages in the correct sequential order 930 to a router 925 of the gateway 920, for the router 940 to forward the data messages in the correct sequential order to their subsequent destination 950 in the SD-WAN. In this example, the data messages are being sent from the router 925 along different network links, shown as data messages 940. In other embodiments, however, the router 925 may forward the data messages in their correct order along a single network link to the subsequent destination. By embedding sequence numbers and re-sequencing the data messages at the destination router, it ensures that data messages are optimally sent to the destination router by being sent along different wireless network links, and that the data messages are sent in the correct order to their subsequent destination.

As discussed previously, an edge router of a vehicle may generate metrics associated with different wireless network links in order to select optimal links for forwarding data messages. For instance, an edge router may iteratively (1) collect metrics quantifying a set of attributes of each network link at different times, and (2) select different network links for forwarding data messages at different times based on the collected metrics. In some embodiments, a network link may be optimal at one time of day, and not optimal at another time of day. In order to ensure that the optimal link is used, the edge router uses the collected metrics to determine which network link is optimal at each time of the day, and uses the optimal link at any given time throughout the day for forwarding data messages.

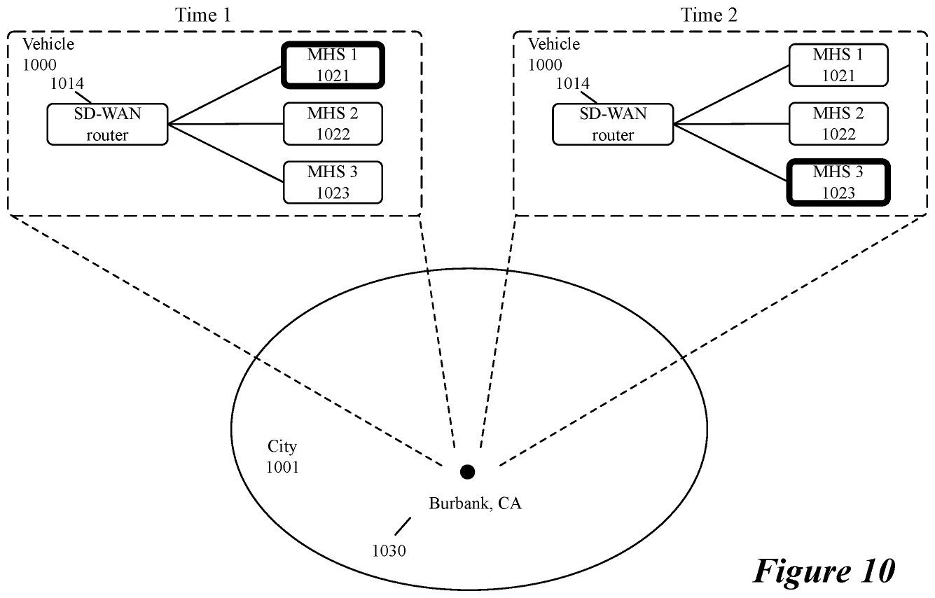

FIG. 10 present an example that illustrates selection of two different links of a stationary vehicle 1000 at two different times. The vehicle 1000 includes an SD-WAN router 1014 and network links 1021-1023 for forwarding data messages to SD-WAN destinations outside of the vehicle 1000. At both times, the vehicle is at the same location 1030 in a city 1001. In this figure, the SD-WAN router 1014 collects metrics to identify the wireless network link that is optimal to use at different times in the day.

At Time 1, the SD-WAN router 1014 has selected network link 1021 for forwarding data message flows, as shown by a bolded line. At Time 2, the SD-WAN router 1014 has selected network link 1023 for forwarding data message flows, as shown by a bolded line. In some embodiments, these different selections of links at different times in the same location may be due to differing signal strength of the network links at different times of the day. For example, network link 1021 may has the strongest signal strength at Time 1, while network link 1023 has the strongest signal strength at Time 2. Alternatively, the selection of the different links might be due to different congestion levels of the different links at different times in the day. Any metrics associated with the network links 1021-1023 may affect which link is optimal at either of the time instances, resulting in different link selections. In this example, only one link is selected at any given time, but it should be noted that in some embodiments, two or more links may be concurrently selected at any given time for a particular flow.

In some embodiments, the edge router may iteratively (1) collect metrics quantifying a set of attributes of each network link at different locations traveled by the vehicle, and (2) select different network links for forwarding data messages at the different locations based on the collected metrics. As the vehicle moves throughout different locations, the network links will strengthen or weaken as the vehicle moves closer to and farther away from different cellular towers. The edge router may collect metrics for the network links at various different locations to determine which links are optimal at the various locations, such that the edge router can forward data messages using the optimal wireless network links when the vehicle is at each location.

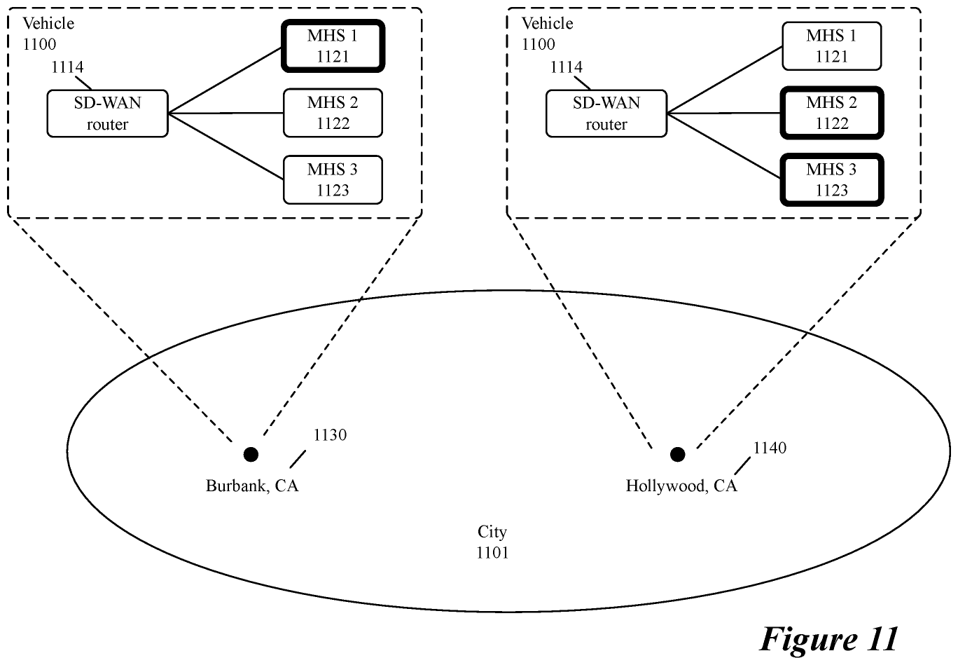

FIG. 11 present an example that illustrates selection of two different links of a moving vehicle 1100 at two different locations in a city 1101. The vehicle 1100 includes an SD-WAN router 1114 and three network links 1121-1123. In this figure, the SD-WAN router 1114 collects metrics associated with the network links 1121-1123 to determine which links are optimal at different physical locations of the vehicle.

At a first location 1130, the SD-WAN router 1114 has selected network link 1121 for forwarding data message flows, as shown by a bolded line. At a second location 1140, the SD-WAN router 1114 has selected two network links 1122 and 1123 for forwarding data messages. In some embodiments, only one link is selected for each location of the vehicle. In other embodiments, as in this example, multiple links may be selected, e.g., based on a metric of the links meeting a minimum threshold. For example, for links selected based on signal strength, the SD-WAN router 1114 may select all links that meet or exceed a minimum signal strength, and only links not meeting that minimum signal strength are not used.

In some embodiments, distinct locations are defined such that a link selection process is performed at each of those distinct locations. For instance, a fixed distance may be defined such that for every “X” distance the vehicle travels, the edge router of the vehicle performs a link selection process to determine which link or links to use at that location of the vehicle. For example, the edge router may be configured to select new links every 1/10^{th} of a mile that the vehicle travels. In other embodiments, different location points may be defined such that when the vehicle reaches each specified location, the link selection process is performed.

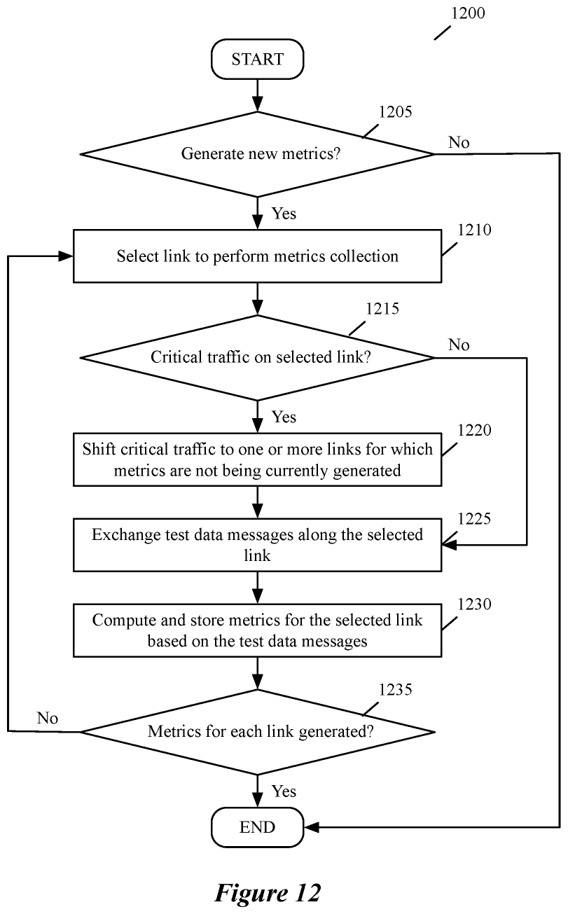

FIG. 12 conceptually illustrates a process 1200 of some embodiments for generating metrics associated with network links. This process may be performed by an edge router of a vehicle or a metric collector that executes along with the edge router on the vehicle. In some embodiments, this process is performed to determine the available bandwidth of each link at a particular location so that the edge router can select the optimal link or links at this location based on their available bandwidth.

The process 1200 begins by determining (at 1205) whether to generate new metrics for each link used to forward data messages from the vehicle to one or more destinations. The edge router may determine this based on the time of day if the edge router is configured to generate new metrics periodically. The edge router may also determine this based on the location of the vehicle. For instance, as the vehicle moves, the metrics generated for each link may change (e.g., as the links change distances from different cellular towers). Hence, the edge router can perform this process 1200 periodically when the vehicle is at different locations. In some embodiments, a fixed distance (e.g., specified by a user or administrator) is used to determine when the process 1200 is performed, such that the process 1200 is performed a first time at a first location, and then a second time at a second location that is the fixed distance away from the first location. These two locations in some embodiments are determined based on global positioning system (GPS) location data provided by a GPS satellite. The two locations of the vehicle in other embodiments are determined based on cellular derived location data.

If the process 1200 determines that new metrics are not to be generated, the process 1200 ends. If the process 1200 determines that new metrics are to be generated, the process 1200 selects (at 1210) a link to perform metrics collection. In some embodiments, the edge router generates metrics for each link one at a time. After selecting a link, the process 1200 determines whether any critical traffic (i.e., critical data messages) is currently being forwarded along the selected link. To facilitate metrics generation without compromising critical traffic that requires high reliability, such traffic should be first shifted to alternate available links. For example, if three carriers on three cellular links are available to the edge router, a first link would entail removal of critical traffic from this link and redistribution of this traffic across one or more of the other links during the brief period of time the metrics generation is performed for the first link.

If the process 1200 determines that critical traffic is being sent along the selected wireless network link, the process 1200 shifts (at 530) the critical data messages to be forwarded over one or more of the other links for which metrics are not being currently generated. Once metrics for the selected link is finished, the edge router may shift the critical data messages back over to this link while metrics generation is performed for the other links. If the process 1200 determines that critical traffic is not being sent along the selected link, the process 1200 proceeds to 1225. At 1225, the process 1200 exchanges test data messages with a destination router of the SD-WAN along the selected link. The edge router exchanges these test data messages with the destination router (e.g., a gateway or an edge node) in order to gather information about the selected network link. Exchanging test data messages along the selected network link includes exchanging a minimal quantity of data in order to minimize the adverse effect of ongoing SD-WAN transmissions.

After the test data messages have been exchanged, the process 1200 computes and stores (at 1230) metrics for the selected link based on the test data messages. In the example of calculating available bandwidth of the links, the edge router determines a transmission duration for each test data message exchanged along the selected link. Based on the transmission durations for each test data message, the edge router determines a transmission rate of the selected link. Based on the transmission rate, the edge router determines the available bandwidth for the selected link. The process 1200 then determines (at 1235) whether metrics have been generated for each network link connected to the edge router. If metrics have not been generated for all links, the process 1200 returns to 1200 to select a new link to perform metrics collection. If metrics have been generated for all links, the process 1200 ends.

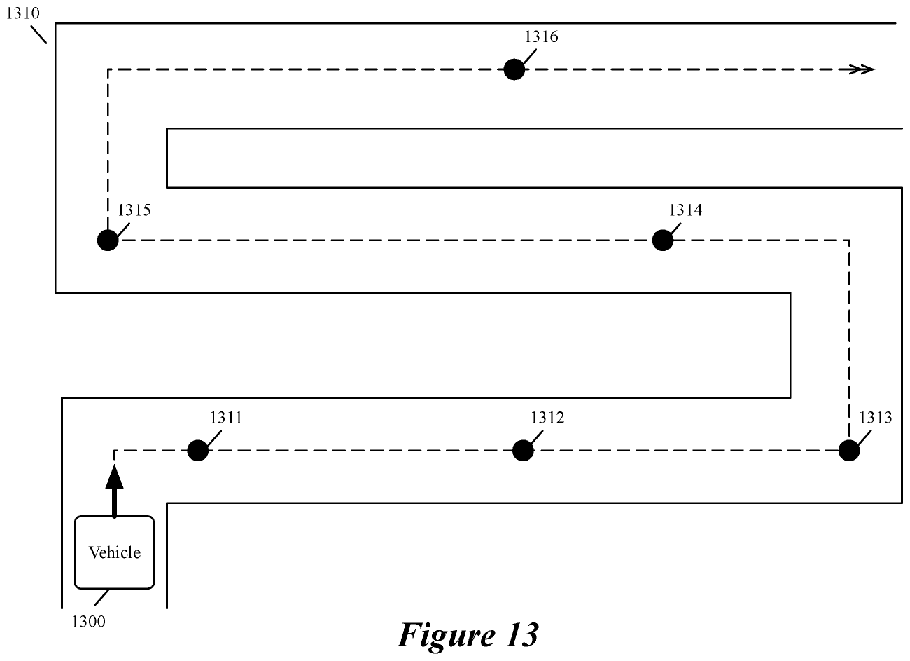

In some embodiments, a vehicle proactively selects links to use at different locations along a route before it reaches these locations. FIG. 13 illustrates an example vehicle 1300 travelling along a route 1310. Before reaching any of these locations, the vehicle's SD-WAN router identifies six possible locations 1311-1316 where this router should select another wireless link for one or more flows that it might forward through the SD-WAN. To do this, the vehicle's SD-WAN router in some embodiments uses metrics that it has previously collected for these locations, and/or metrics for these locations that it collects in real time from one or more servers (e.g., the controller cluster or another server cluster) or one or more vehicles that are concurrently operating in the field.

In some embodiments, the SD-WAN router of the vehicle 1300 as it reaches each location 1311 to 1316 changes its selected wireless network link for one or more flows at this location, in order to more seamlessly transition between the network links. Alternatively, in other embodiments, the SD-WAN router simply uses the links that it identifies for each location 1311-1316 as an initial wireless link candidate for that location, and might forego using the candidate wireless link for a location if it collects metrics at the location that demonstrate that the candidate link is no longer the best link for a set of flows for which it was identified apriori as an optimal wireless link.

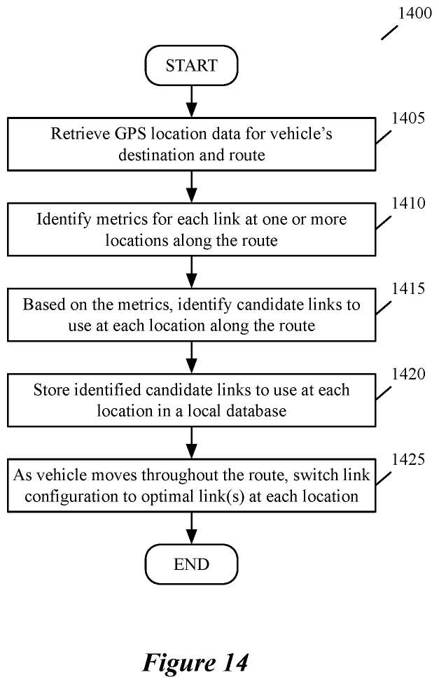

FIG. 14 conceptually illustrates a process 1400 for proactively selecting links along various locations of a future route of the vehicle. This process 1400 may be performed by an edge router of the vehicle. The process 1400 begins by retrieving (at 1405) GPS location data for the vehicle's destination and the route. The edge router retrieves this data in order to plan the route that the vehicle will take and plan which links to use along the route. The GPS location data may be retrieved from a GPS satellite, a server, another vehicle, or any suitable source.

Next, at 1410, the process 1400 identifies metrics for each link at one or more locations along the route. In some embodiments, these locations are defined by where the retrieved metrics were collected or generated. In other embodiments, the locations are defined by the edge router based on a configuration of the edge router. For example, the edge router may be configured to define these locations along the route based on a fixed distance such that a location is defined along every “X” distance along the route. the edge router may instead be configured to define the locations based on location definition data received from a user or administrator, specifying specific locations for which the edge router should select new links. In such embodiments, the edge router uses the received location definition data to determine one or more locations on the vehicle's route.

In some embodiments, the edge router retrieves the link metrics by computing a metrics generation process, such as the process 1200 of FIG. 12. These retrieved metrics may also be historical (i.e., previously generated or collected) metrics (1) stored in and retrieved from a local database in the vehicle, (2) retrieved from one or more servers, and/or (3) retrieved from one or more other vehicles concurrently in the field with the vehicle and/or previously in the field. The retrieved metrics in some embodiments are validated by the vehicle by running tests as the vehicle travels along a route. For instance, if the vehicle retrieves location based link metrics from another vehicle, the edge router of the vehicle may perform methods and processes to validate these metrics as the vehicle reaches the locations at which the metrics were collected.

Based on the retrieved metrics, the process 1400 identifies (at 1415) candidate links to use at each location along the route. The edge router determines optimal links for each defined location along the vehicle's route in order for the vehicle to predict which links are optimal along the route. the process 1400 then stores (at 1420) the identified candidate links to use at each location in a local database. the edge router stores the candidate link selections in a local database so the edge router can identify the candidate links as the vehicle reaches the various locations along the route.

As the vehicle moves throughout the route, the process 1400 switches (at 1425) the vehicle's link configuration to optimal link(s) at each location along the route. In some embodiments, the edge router always selects the candidate links at the various locations along the route. In other embodiments, the edge router may select the candidate links along the route, or may not select them. In such embodiments, the edge router may also generate new metrics for each location and determine a new link selection at the location. If the new link selection is different than the predicted candidate link selection, the edge router can use the new link selection. After 1425, the process 1400 ends.

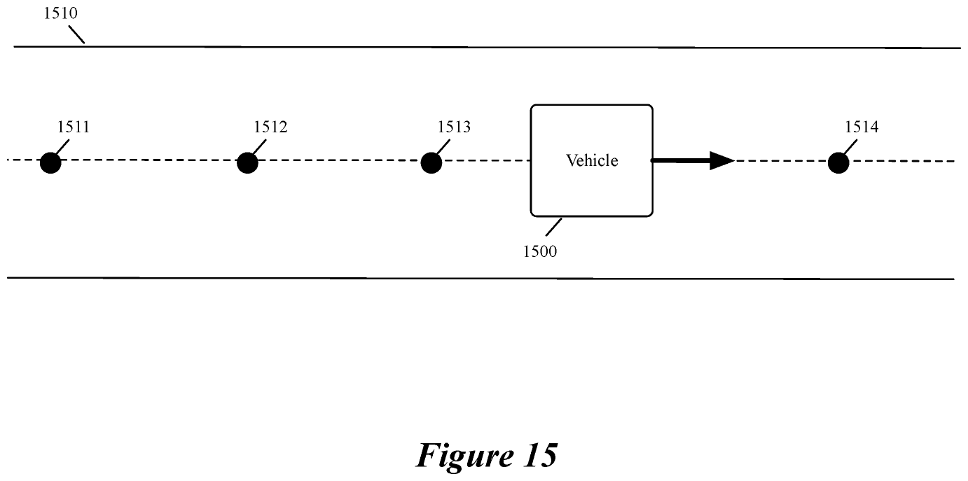

FIG. 15 illustrates an example vehicle 1500 travelling along a straight route 1510. The vehicle 1500 has collected metrics 1511-1513 for links at previous locations of the vehicle, but has not yet collected any metrics or selected any links at a future location 1514. In order to predict which link or links to use at this future location 1514, the vehicle 1500 of some embodiments uses a predictive modeling method using metrics taken at previous locations 1511-1513. In this example, the vehicle 1500 is travelling in a straight line, so the vehicle 1511 is able to use a simple distance scheme for predicting future location metrics. For instance, the vehicle 1300 is able to determine a one-dimensional distance between itself and each of the past locations 1511-1513 and the future location 1514. In other embodiments, a vehicle does not travel along a straight line. In such embodiments, the vehicle can utilize trigonometric functions to more accurately estimate the predicted link selection at future locations, based on the vehicle's direction, speed, and the estimate future location in relation to each link's previous metrics.

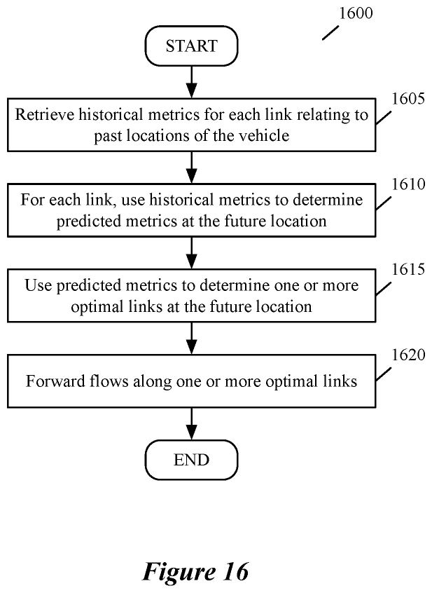

FIG. 16 conceptually illustrates a process 1600 of some embodiments for distributing data message flows across multiple network links for forwarding from a device operating in a vehicle to an SD-WAN. This process 1600 may be performed by an edge router operating in the vehicle, which may be an edge router appliance, an edge router that executes on a computer that operates in the vehicle, or an edge router that executes on a machine that executes on the computer. This process 1600 dynamically distributes data message flows among network links by predicting metrics of each network link at future locations of the vehicle. For instance, this process 1600 can be used to predict signal strength of each network link at the vehicle's future locations and select links based on the predicted signal strength.

The process 1600 begins by retrieving (at 1605) historical metrics for each link relating to past locations of the vehicle. The edge router may retrieve these metrics from a local database (e.g., if the edge router previously generated these metrics), from a server, or from another vehicle that generated the metrics. In some embodiments, the edge router retrieves these metrics by sending an application programming interface (API) request to a networking interface to request the metrics. The networking interface then sends back an API response which includes the requested metrics. In some embodiments, these metrics are performance metrics of the network links, such as signal strength metrics, transmission rate metrics, etc. In other embodiments, these metrics are non-performance metrics. Still, in other embodiments, the metrics are a combination of performance and non-performance metrics. The metrics received for each network link include metrics for multiple locations traversed by the vehicle. In some embodiments, the previous locations, the current location, and the future location of the vehicle are determined based on GPS location data provided by a GPS satellite. In other embodiments, the past, current, and future locations are determined based on cellular derived location data.

Next, for each link, the process 1600 uses (at 1610) the historical metrics to determine one or more predicted metrics at the future location of the vehicle. In some embodiments, the edge router uses the historical metrics for each link to generate a linear regression for each link. For a particular wireless network link, the edge router plots data points for metrics of the link against the locations where the metrics were collected to generate a linear regression line. This line indicates the future metrics for this link at future locations of the vehicle. Further information regarding this linear regression will be described below.

The process 1600 uses (at 1615) the predicted metrics for each link to determine one or more optimal links at the future location. The edge router determines one or more optimal links for forwarding the flows when the predicted metrics for those links at the future location exceed (or in some embodiments, meet or exceed) a particular minimum threshold. The edge router does not determine a link as optimal when the predicted metrics for that link at the particular future location does not meet or exceed the particular minimum threshold. The minimum threshold can be determined by a user or administrator. For instance, when the edge router selects links based on signal strength metrics, the edge router uses historical signal strength metrics for each link to determine the predicted signal strength at the vehicle's future location (i.e., a particular distance away from its current location). Based on the predicted signal strengths of the links, the edge router can select the optimal links for use at the future location and ensure that non-optimal links are not used at the future location. A link is considered non-optimal when its predicted signal strength falls below a particular minimum signal strength score (i.e., the minimum threshold). When a link's signal strength falls below this minimum signal strength score, data message flows sent along this link are at risk of congestion. In order to avoid this, the edge router only uses links whose predicted signal strength stays above the desired minimum.

The process 1600 then forwards (at 1620) data message flows along one or more optimal links. In some embodiments, the edge router does this before reaching the future location. In other embodiments, the edge router waits to do this until it reaches the future location. In some embodiments, the edge router, in selecting network links based on their predicted metrics, forwards all data message flows using one network link. In other embodiments, the edge router forwards different data message flows using different network links. Still, in other embodiments, the edge router forwards different data messages of a particular flow using one network link. Once the edge router forwards the data message flows using the optimal network link or links, the process 1600 ends.

As described above, some embodiments leverage a set of dynamic assessment methodologies to establish ongoing quality assessment of each of the carrier provided data links. These assessments in some embodiments measuring signal quality and estimates for bandwidth up and down on each link. SD-WAN processes (e.g., SD-WAN DMPO and other processes provide by VMware's VeloCloud technology) in some embodiments is then able to make intelligent assessment of which packets to place on each of the several link based on link quality and traffic type. For example, traffic that is meant to be highly reliable can be placed on the link deemed most reliable while traffic that may be bandwidth intensive but less sensitive to outages could be placed onto the higher speed links. Packets are given a sequence number that is embedded into the packet and captured upstream at the SD-WAN gateway device which re-sequenced these packets in their original transmission order, sending them onward to their destination from the gateway in their proper order.

Different embodiments use different methods of measuring link quality. Some embodiments use location aware spot-burst bandwidth assessment. As vehicles move at speed through the landscape, their cellular coverage conditions from the multiple carriers enabled on their SD-WAN routers may change in proportion to their speed. In short, the more rapidly vehicles move, the faster they pass through cell tower fields of coverage which may result in changing signal conditions.

To optimize bandwidth assessment, the ‘GPS’ location data provided either by satellite GPS or cellular derived location data is used to establish location and direction. A policy established on the SD-WAN device or SD-WAN orchestration layer can be established to indicate at which stepping distances speed tests will be performed, i.e. once the vehicle is X distance away from the last point of spot-testing in any direction, a new test will be performed. For example, whenever the vehicle is ½ mile away from the location of the last spot assessment a new spot assessment will be performed.

In a spot assessment, the vehicle will send a short burst of packets up and down on the targeted cellular link (a short speed test), to establish the available transmission rates in both directions, this testing itself being kept to a minimal quantity of data so as to minimize adverse effect to the ongoing SD-WAN production transmissions. The performance of a spot tests itself is designed to temporarily saturate a link so that its current maximum bandwidth in both directions can be established. For example, a chunk of data (a file), of fixed size (i.e. 250 KB), is sent to and received from a nearby SD-WAN gateway location and the duration of transmission is used to calculate the effective available bandwidth in each direction at the location of interest.

To facilitate the spot test without compromising critical traffic that requires high reliability, such traffic should be first shifted to alternate links available on the SD-WAN device. For example, if three carriers on through cellular links are available to the SD-WAN device, testing link #1 would entail removal of ‘critical traffic’ from link #1 and re-distributing across links #2 and #3 during the brief period of the burst test on Link #1.

For example, if the SD-WAN device has 3 links from 3 separate carriers, with estimated approximately 15 Mbit/s bandwidths down and 5 Mbit/s up on each link, in a scenario where a total of 24 Mbit/sec of traffic is currently being received and 9 Mbit/sec is being sent, these traffic streams will be initially spread across the 3 links in approximately equal measure with 8 Mbit/sec being received on each link and 3 Mbit/sec being sent on each link.

During the interval of the test, the SD-WAN device has some outbound traffic designated as ‘critical traffic’ on link 1—, so this is initially skipped, and will be revisited after other links complete their tests. Link 2 is then targeted for the initial test, and there may be no critical traffic on link 2, so a burst of traffic is placed on this link in addition to the traffic load it is already carrying with the test traffic stream generating 9 Mbit/sec download speed in addition to its current traffic, yielding a download speed estimate of 17 Mbit/sec, and a total of 2.7 Mbit/sec upload for a total estimate of 5.7 Mbit/sec upload speed. Upon completion of this test and a similar test on link #3, the test resumes on link #1 but the critical traffic is still on link #1 so it is relocated to links 2+, the relocated traffic streams can be resume on Link #1, and the process can then repeat for Link #2 and Link #3.

While burst testing on multiple links in parallel is possible, it is only advised if the critical path traffic flow rates can be safely redistributed across the other available links without exceeded their estimated maximum bandwidths. Once the bandwidth estimates of the 3 links are establish at the spot-test location, traffic can then be placed across these links in an optimal placement configuration based on the newly established bandwidth of each link, until the next spot-test location is reached at which time the process will repeat. The strict adherence to the distance-based testing protocol can be further optimized based on the current traffic pattern, with spot tests being delayed or skipped if all links are very active or critical traffic flows cannot be placed onto a subset of the links to facilitate a link test.

Another method uses Radio Telemetry Based Reliability Assessment. In some configurations, the cellular radios used by the SD-WAN device will enable access to radio level telemetry through an API call made to their networking interface. An example includes the Multitech r100 series, which performs LTE to ethernet bridging functions, allowing the SD-WAN device to engage with it as a generic network WAN connection. It does however also provide an API which can be interrogated by the SD-WAN device at will through the network interface to obtain real-time radio signal quality measurements such as signal strength measurements.

This capability allows for an enhanced method of assessing link quality and reliability than the above-described dynamic spot testing method can provide on its own. While the spot testing method provides ongoing bandwidth assessments, it yields less information about the future reliability of each of the underlying cellular links which may potentially degrade rapidly after a short distance in some cases due to features of the landscape, or other factors.

In this method, a regular location-based model informed by GPS based location is merged with a predictive model of signal strength generated by an ongoing linear regression model which is formed based on signal strength measurements from recent measurements taken at a regular distance such as 1/10^{th} of a mile. These historical measurements are used to predict a forward looking linear regression based line indicating likely future signal strength in the direction of travel.

In the event that the forward predicting line passes below a signal quality threshold defined by policy within the orchestration layer or SD-WAN device, the SD-WAN packet schedule will pre-emptively shift packets away from the link(s) predicted to fall below acceptable quality and only link predicted to maintain, improve, or otherwise stay above the ‘signal floor’ defined. This pre-emptive action will allow for quality to be maintained with higher probability of short micro-outages that may occur while the SD-WAN software otherwise reactively moves packets onto better links upon detection of link degradation during a next-burst spot test or in response to actually degraded network packet flows.

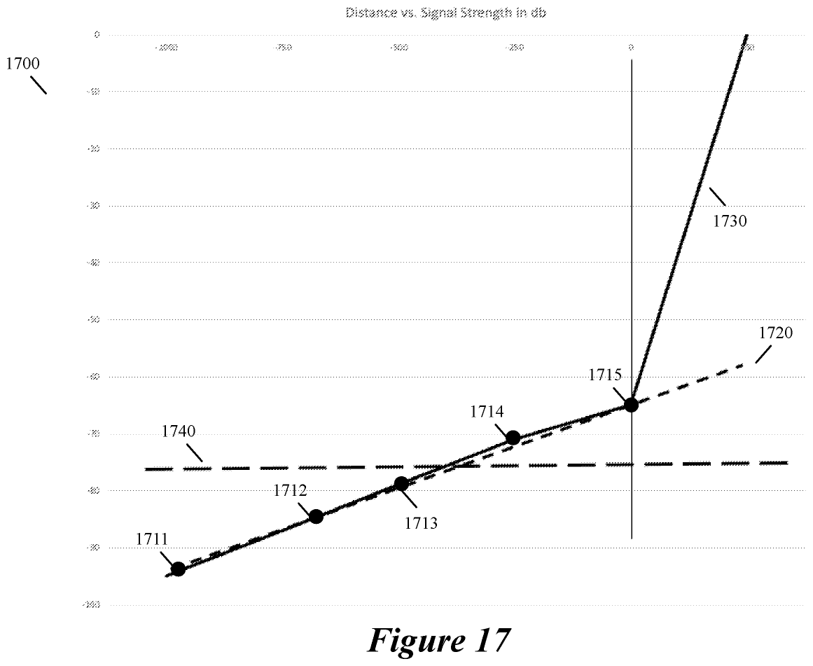

FIG. 17 illustrates an example linear regression graph 1700 generated by an edge router for selecting network links based on predicted metrics. The graph 1700 shows five collected metrics as datapoints 1711-1715. These datapoints 1711-1715 each correspond to a metric retrieved for a given wireless network link at a different location of the vehicle. In this example, metrics are collected for signal strength (in decibels (dB)) at various distances from the current location of the vehicle. A linear regression line 1720 is drawn to correlate the datapoints 1711-1715 into a single line. Using this line, a predicted signal quality line 1730 is plotted to show the predicted signal strength of the network link at future locations of the vehicle. If the predicted signal quality line 1730 were to fall below the minimum signal strength threshold 1740 set by a defined policy, the edge router would be able to determine that this link is not optimal for use along the vehicle's future route. In this example, using the minimum threshold 1740, the edge router can determine that this network link's signal strength at future locations is predicted to be above the minimum signal strength quality, and the edge router can then determine that this network link is optimal for forwarding data message flows at future locations of the vehicle.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

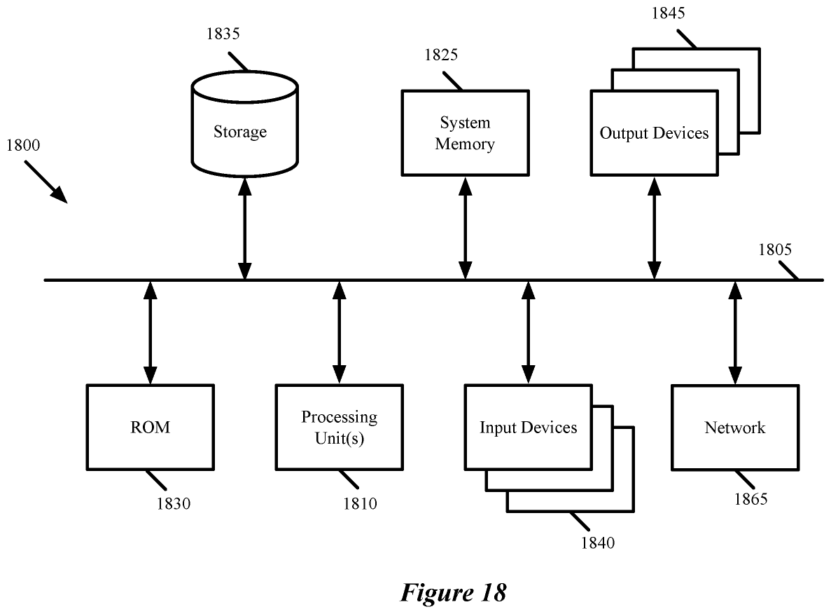

FIG. 18 conceptually illustrates a computer system 1800 with which some embodiments of the invention are implemented. The computer system 1800 can be used to implement any of the above-described computers and servers. As such, it can be used to execute any of the above described processes. This computer system includes various types of non-transitory machine readable media and interfaces for various other types of machine readable media. Computer system 1800 includes a bus 1805, processing unit(s) 1810, a system memory 1825, a read-only memory 1830, a permanent storage device 1835, input devices 1840, and output devices 1845.

The bus 1805 collectively represents all system, peripheral, and chipset buses that communicatively connect the numerous internal devices of the computer system 1800. For instance, the bus 1805 communicatively connects the processing unit(s) 1810 with the read-only memory 1830, the system memory 1825, and the permanent storage device 1835.

From these various memory units, the processing unit(s) 1810 retrieve instructions to execute and data to process in order to execute the processes of the invention. The processing unit(s) may be a single processor or a multi-core processor in different embodiments. The read-only-memory (ROM) 1830 stores static data and instructions that are needed by the processing unit(s) 1810 and other modules of the computer system. The permanent storage device 1835, on the other hand, is a read-and-write memory device. This device is a non-volatile memory unit that stores instructions and data even when the computer system 1800 is off. Some embodiments of the invention use a mass-storage device (such as a magnetic or optical disk and its corresponding disk drive) as the permanent storage device 1835.

Other embodiments use a removable storage device (such as a flash drive, etc.) as the permanent storage device. Like the permanent storage device 1835, the system memory 1825 is a read-and-write memory device. However, unlike storage device 1835, the system memory is a volatile read-and-write memory, such a random access memory. The system memory stores some of the instructions and data that the processor needs at runtime. In some embodiments, the invention's processes are stored in the system memory 1825, the permanent storage device 1835, and/or the read-only memory 1830. From these various memory units, the processing unit(s) 1810 retrieve instructions to execute and data to process in order to execute the processes of some embodiments.

The bus 1805 also connects to the input and output devices 1840 and 1845. The input devices enable the user to communicate information and select commands to the computer system. The input devices 1840 include alphanumeric keyboards and pointing devices (also called “cursor control devices”). The output devices 1845 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 18, bus 1805 also couples computer system 1800 to a network 1865 through a network adapter (not shown). In this manner, the computer can be a part of a network of computers (such as a local area network (“LAN”), a wide area network (“WAN”), or an Intranet, or a network of networks, such as the Internet. Any or all components of computer system 1800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of dynamically distributing data message flows across a plurality of wireless network links for forwarding from a device operating in a vehicle to a software-defined wide area network (SD-WAN), the method comprising:
at an edge router operating in the vehicle:
retrieving a plurality of metrics for each wireless network link in the set of wireless network links;
based on the retrieved plurality of metrics, determining one or more predicted metrics for each wireless network link; and
based on the predicted metrics, forwarding the data message flows to a destination router of the SD-WAN using the plurality of wireless network links.

2. The method of claim 1, wherein retrieving the plurality of metrics for each wireless network link comprises:
sending an application programming interface (API) request to a networking interface to request the plurality of metrics; and
receiving an API response from the networking interface comprising the requested plurality of metrics.

3. The method of claim 1, wherein determining the one or more predicted metrics for each wireless network link comprises:
for each wireless network link:
using two or more metrics associated with the wireless network link to generate a linear regression for the wireless network link; and
using the linear regression to determine the predicted metrics for the wireless network link.

4. The method of claim 3, wherein the predicted metrics for each wireless network link comprise predicted metrics for the wireless network link at future locations of the vehicle.

5. The method of claim 4, wherein forwarding the data message flows to the destination router using the plurality of wireless network links comprises:
when the vehicle reaches a particular future location:
selecting one or more wireless network links for forwarding the data message flows when the predicted metrics for the one or more wireless network links at the particular future location exceed a particular minimum threshold; and
not selecting one or more wireless network links for forwarding the data message flows when the predicted metrics for the one or more wireless network links at the particular future location do not exceed the particular minimum threshold.

6. The method of claim 5, wherein the particular minimum threshold is determined by a user or administrator.

7. The method of claim 4, wherein the future locations of the vehicle and a current location of the vehicle are determined based on global positioning system (GPS) location data provided by a GPS satellite.

8. The method of claim 4, wherein the future locations of the vehicle and a current location of the vehicle are determined based on cellular derived location data.

9. The method of claim 1, wherein the predicted metrics comprise signal strength metrics for each of the wireless network links.

10. The method of claim 1, wherein forwarding the data message flows to the destination router using the plurality of wireless network links comprises forwarding the data message flows using one wireless network link.

11. The method of claim 1, wherein forwarding the data message flows to the destination router using the plurality of wireless network links comprises forwarding the data message flows along different wireless network links.

12. The method of claim 11, wherein forwarding the data message flows along different wireless network links comprises forwarding data messages of a particular flow along different wireless network links.

13. The method of claim 1, wherein the edge router is one of (i) an edge router appliance, (ii) an edge router that executes on a computer that operates in the vehicle, or (iii) an edge router that executes on a machine that executes on the computer.

14. The method of claim 1, wherein the device is one of (i) a machine executing on a computer that operates in the vehicle, or (ii) the computer.

15. The method of claim 14, wherein the machine is one of a virtual machine (VM), a Pod, or a container.

16. A non-transitory machine readable medium storing a program for execution by at least one processor of an edge router operating in a vehicle, the program dynamically distributing data message flows across a plurality of wireless network links for forwarding from a device operating in the vehicle to a software-defined wide area network (SD-WAN), the program comprising:
retrieving a plurality of metrics for each wireless network link in the set of wireless network links;
based on the retrieved plurality of metrics, determining one or more predicted metrics for each wireless network link; and
based on the predicted metrics, forwarding the data message flows to a destination router of the SD-WAN using the plurality of wireless network links.

17. The non-transitory machine readable medium of claim 16, wherein the set of instructions for retrieving the plurality of metrics for each wireless network link comprises sets of instructions for:
sending an application programming interface (API) request to a networking interface to request the plurality of metrics; and
receiving an API response from the networking interface comprising the requested plurality of metrics.

18. The non-transitory machine readable medium of claim 16, wherein the set of instructions for determining the one or more predicted metrics for each wireless network link comprises sets of instructions for:
for each wireless network link:
using two or more metrics associated with the wireless network link to generate a linear regression for the wireless network link; and
using the linear regression to determine the predicted metrics for the wireless network link.

19. The non-transitory machine readable medium of claim 18, wherein the predicted metrics for each wireless network link comprise predicted metrics for the wireless network link at future locations of the vehicle.

20. The non-transitory machine readable medium of claim 19, wherein the future locations of the vehicle and a current location of the vehicle are determined based on global positioning system (GPS) location data provided by a GPS satellite.
